(19) United States
(12) Patent Application Publication
(10) Pub. No.: US 2013/0111659 A1
(43) Pub. Date: May 9, 2013

(54) Better Electric Person Transfer, Load and Unload Device

(71) Applicant: Robert G. McKenzie, Nth Balwyn (AU)

(72) Inventor: Robert G. McKenzie, Nth Balwyn (AU)

(21) Appl. No.: 13/518,596

(22) PCT Filed: Dec. 31, 2010
(86) PCT No.: PCT/AU2010/001756

§ 371 Date: Jul. 17, 2012

(30) Foreign Application Priority Data
Dec. 31, 2009 (AU) 2009251224

(51) Int. Cl. A61G 7/10

(52) U.S. Cl. CPC A61G 7/1017; A61G 7/1046
USPC 5/86.1

(57) ABSTRACT

A person load and unload transfer device including: an adjustable wheeled base frame;

a support structure movably mounted on the adjustable base frame;

a person load and unload assembly mounted to a portion of the support structure wherein the assembly includes a person receiving portion adapted to change configuration between a load and unload condition;

an actuator mechanism mounted on the base frame adapted to selectively control the assembly between a load and unload operating condition;

wherein in a load operating condition the assembly urges the person receiving portion thereof to adopt an angled position relative to the wheeled base to stably receive an person for transfer; and

wherein when the actuator mechanism is selected for an unloading operating condition, the assembly alters the angle of the person receiving portion to allow transfer of the person from the transfer device. The geometry of the person support assembly is such that it helps to keep the person in the upright position as it moves from the load or unload position to its position in the center of the person transfer device. Furthermore a seat mechanism is such that it allows the seat mechanism to slide easily between the persons legs and the chair or the like. There is a joystick or the like that controls the movements of the chair and chest support mechanism. There are a series of position sensors and pressure sensors and an onboard computation device that receives input from the sensors and the controlling joystick to calculate appropriate movement of the actuators while preventing undue pressure on the persons body.

Patents cited:

U.S. Pat. No. 5,388,289 14, Feb., 1995 to D L Casperson Combnation wheelchair and Lift

U.S. Pat. No. 7,240,621 B2 Jul. 10 2007 to M Chepurny, G Molner M Wilson Personal lift device

U.S. Pat. No. 5,001,789 Mar. 26, 1991 to L V Schoenberger Invalid lift and transfer apparatus

U S Pat no 2007/0085405 Apr. 19 2007 to J Grotner Device for assisting Disabled persons

UPC 7170 760 528 25 (sit to stand lifter).

U S Patent 7003820 B1 on Feb. 28 2006 by T. Iura , Y. Tsukamara , K. Yamamoto Supportive device for handicapped people

### BACKGROUND

People with general disability, or neuromuscular weakness from any cause are often completely dependent on carers for their every movement.

Inability to move from room to room , to bed to the dinner table or to the chair or the toilet unaided is one of the most frustrating aspects of immobility. Moving to the toilet and post toileting cleaning is particularly problematic if it is not done in an efficient and timely manner and importantly in a dignified manner. Preferably in a way that does not put undue strain on the caring staff following the widely adopted no lift policy operating in many hospitals and homes.

Numerous devices have been made which attempt to solve this problem:

U.S. Pat. No. 5,388,289 14, Feb., 1995 to D L Casperson (Combination wheelchair and Lift) or the like employ a sling attached to a ‘coat hanger’ on a hoist but this requires the operation by 2 carers and the persons backside is covered by the sling making the process of lifting the patient and removing the sling, time consuming and difficult, especially in a heavy patient. Using such a device is overkill if patients have the ability to sit up.

Likewise ceiling mounted sling devices like U.S. Pat. No. 7,240,621 B2 Jul 10, 2007 to M Chepurny, G Molner M Wilson (Personal lift device)

Involve the use of a sling and are expensive to purchase and to mount on the ceiling and are limited to operating in the room they are installed U.S. Pat. No 5,001,789 Mar. 26, 1991 to L V Schoenberger (Invalid lift and transfer apparatus) is a device that lifts the patient leaving the backside exposed to aid with ease of toileting. But this device lifts the patient into an undignified face down position and potentially dangerous position far too high off the ground causing anxiety to staff and patient alike.

U S Pat no 2007/0085405 Apr. 19, 2007 to J Grotner (Device for assisting Disabled persons) is like other devices used in nursing homes for patients that have the ability to stand. The device shown by Grotner differs from the nursing home type in that his device does not have a foot platform for the patient to stand on, nor does it have wheels. Such devices that are mobile with footplate include the device UPC 7170 760 528 25 (sit to stand lifter—lumex easy lift). The drawback of this device is that patients must have sufficient leg strength to hold their body weight stably while being wheeled into another position by the attender. Mobile versions are generally used for very short distance transfers, say bed to wheelchair. U.S. Pat. No. 7,003,820 B1 on Feb. 28, 2006 by T. Iura , Y. Tsukamara , K. Yamamoto (Supportive device for handicapped people) this describes a manually operated device which has a back support and thigh support to lift the patient. There is no chest strap shown so all of the weight of the patient is taken by these 2 supports. Unlike the 3 investigators in that patent, this investigator had already found shortcomings with such a means to support the patient. This investigator had already independently without knowledge of the three investigators built and trialed a similar system and found such support to be insecure. The patient tended to slump and attempted to slide into the space between the back support and the thigh support. Furthermore this investigator had independently trialed thigh supports similar to those used by the 3 investigators and had to abandon them. They were cumbersome to get under a patient; they required much lifting and manouvering of the patient and alteration of the height and position of the device to enable them to be secured under the patients thighs and often it was not possible to place them under the patients thighs, partly because of the arm rests on the chairs. As a result, as stated in that patent by the 3 investigators, the patient is required to sit on the edge of the chair for loading by the device and is placed back on the edge of the chair by the device when unloading. This has been discussed at some length with health care professionals and found to be totally unacceptable and for good reason. The risk of falls is too great. The patient must be collected and deposited from and to the center of the chair or toilet on which they are seated.

Most attempts to move a disabled patient have significant drawbacks because they suffer in one or more of the following shortcomings: they are large and cumbersome, they require 2 people to operate, they have a hoist that uses a sling that is cumbersome and requires lifting of the patient at risk to patient and carers, they do not allow easy access to the patients bottom for toileting purposes, they are undignified or they lift the patient into dangerous positions or they require leg or other strength that the patient does not have.

Therefore there is a continuing need to improve devices so that patients' needs can be met, safely and without putting strain on carers backs. Here is such a device.

### DETAILED DESCRIPTION OF PREFERRED EMBODIMENT

Here is a preferred embodiment of such a device. From here on the device will be referred to as “device” or “the device”. The person with the disability will be referred to as “the person” while the person who operates the device will be called the attendant.

FIG. 1. This is an elevated and side on view which shows the base upon which is mounted the person support structure. The said person support structure (not shown in FIG. 1 but is shown in FIG. 2) comprises everything above the said base. The said base is “Y” shaped and consists of the two arms 4 of the said “Y” a cross strut 8 at the top of the said “Y” , a smaller cross strut and a swivel cross strut 7 upon which the said person support structure is supported. At either end of the said cross strut 8 are connected the wheel spans 2 which can pivot at 5 thus allowing the other end of the said wheel spans to separate allowing the base to move in closer to a chair. At 3 is another cross strut which allows the said wheel support arms to separate. There are electronic brakes 9 that can be applied to the wheels 1 to stabilize the device when required.

FIG. 2 This is a pure side elevation. This shows the previously said person support structure mounted on the said base by the pivot at 7. The pure side elevation conceals the said ‘Y’ shaped components of the base behind the said wheel support arms. There is a shin strut at 23, connected to the said base at 7. There is a thigh strut 22 connected to the said shin strut. This said thigh strut is connected to the body strut 24. The said body strut connects via a link strut 21 back to the said pivot point at 7. Together the intersection points of these said struts 23, 22, 24 and 21 make a quadrilateral at joints at 7, 216, 215, and 214 .Each of these said joints allow for hinge type movement so that the said quadrilateral can change its shape.

Attached to the said body support at 211 strut are two chest support struts 25 to which is attached the chest strut 217 to which holds the persons chest support 26. A cross beam 218 is attached to the said chest strut. To this is attached on each end a swivel mechanism 27 to which there is a connect mechanism 28 for attaching the seat (said seat not shown). There is a secondary linear actuator 212 that tilts the said chest support struts either up or down depending on whether the said linear actuator 212 it is shortening or lengthening.

FIG. 3 This shows the just said position of the said chest strut 217 after the said secondary linear actuator 212 has shortened pushing the said chest support up and to the right. The direction of movement is indicated by the arrow 220.

FIG. 4 shows the effect of shortening of the said primary linear actuator.

There is a primary linear actuator 213 which on shortening causes the said quadrilateral (from FIG. 2 made up of points 7, 216, 215, and 214) to pivot foreword on its said pivot at 7. When the said shin support strut 23 hit's the block 219, the said quadrilateral changes its geometry so that the said body strut 24 and said chest strut 217 become more vertical.

FIG. 5 shows a person sitting on his seat or other furniture. The seat support 55 has been inserted under the patient. The previously said device has been wheeled up to the patient who is sitting with legs slightly apart. A seat support 55 is placed under the persons thighs. The said seat support has been connected by seat arms 56 to the previously said seat connect 28 (59 in FIG. 5). The person leans foreword and a strap is placed around the person back to secure his chest to the said chest support 26

FIG. 6 Shows the person loaded on to the device and seated on said seat support and chest strapped with strap 61 to said chest support.

FIG. 7 A Shows a magnified cutout of FIG. 5.

FIG. 7 B shows a further magnified cutout focusing on the said crossbeam 218 and the previously said swivel mechanism 27 and said seat connector 28.

Attached to the end of the said swivel mechanism is a joystick 71 which the attendant can move in any of the directions (as specified by the arrows) to control the position of the previously said crossbeam 218. As the joy stick is moved in a particular direction so there will be coordinated movement of the said linear actuators to achieve a corresponding movement of the said crossbeam and said seat connector. This is important to allow the attendant to position the said crossbeam in the optimal position for connecting the said seat connector to the said seat arms of the seat when loading and unloading the patient.

FIG. 8 Seat mechanism

In its simplest form the seat consists of a seat body contained in parentheses 89 and seat arms 56

The said seat body has 2 sets of rollers 82,83 and 84,85 over which a material belt runs (like a conveyer belt). This said seat is designed to be used by pushing this said seat into the potential space between the persons leg and the surface of the seat on which he sits. The rollers may be a little flexible to allow then to form a slight ‘u’ shape (from 82 to 82a) allowing the said rollers to conform to the shape of the surface of the seat. The rollers are held in place by the end plates 81 which have Axle mounts 86 for the said rollers. (in the diagram the said end plates are distracted form rollers to allow visualization of the components). When the said material belt on the said rollers contact a surface above the person's legs) or below (the chair) and are pushed into that potential space (i.e. toward the front in FIG. 8), the rollers roll outwards in the direction of the arrows. When the said material belt on the said rollers contact a surface above (the person) or below (the chair or furniture) and are pulled back out from between the persons leg and the chair (toward the back in FIG. 8), the rollers roll in the reverse direction. The net effect of this is that the said material belts do not move across the persons skin or leg or the surface of the chair and there is minimal friction on the skin or clothing of the persons leg and minimal friction on the underlying chair or furniture.

FIG. 9 In its preferred embodiment the seat is as follows.

FIG. 9 is a cross sectional view of the seat components 92,93,94 with the persons thighs 91 also in cross section contained under the said seat components 9A and within the seat components 9B

FIG. 9A the said seat components have been lowered into position. Over the persons thighs is the inner thigh containment section 93. There is one for each thigh and the said inner thigh containment sections are fixed together by seat struts 94. The said seat struts have connection 95 to the previously said cross beam (218 in FIG. 2).

FIG. 9B The outer thigh containment sections 92 on each side can be rotated in the direction indicated 97 into the position shown in FIG. 9B by use of the knobs 96, and locked in this position. This contains the thigh ready for lifting.

There is a slot in the said outer thigh containment section to allow it to be fully rotated in the reverse direction to 97 without the leading edge contacting the said seat struts.

FIG. 10 B is a magnified view of the said seat

FIG. 10 C is a further magnified view of the edge of the said seat. This view shows incorporation of the said roller mechanism described in FIG. 8. FIG. 10 C The previously said outer thigh containment sections can be seen 92 and the inner thigh containment section 93 The rollers 84 allow the material belt 101 to roll over the inner and outer sections of the said outer thigh containment sections. The net principle as described in FIG. 8 applies. As the said outer thigh containment section rolls across the said inner thigh containment section, the said two sets of rollers roll into the potential space between the persons leg and the seat they are seated on with out sliding over the surface of the persons leg or the chair. Thus there is no friction on the chair or the persons' leg and so less capacity to do harm.

There is an electronic control device which is programmed to take input from the joy stick and other sensors and feed the appropriate control instructions to the said primary and said secondary linear actuators and electronic brake.

There are angle sensors that detect movement of the various said struts and feed that information back to the said electronic control device.

There are a number of sensors for the persons protection. There are pressure sensors positioned with in the device to detect abnormal loading of the person on the device.

There is an emergency stop button. When pressed the device stops its current activity. A long press causes the device to reverse the process it was attempting in small increments.

The person also wears an emergency alarm device that is unrelated to this device but can be used in case of emergency to call for help.

### SUMMARY

A person load and unload transfer device including:

an adjustable wheeled base frame;

a support structure movably mounted on the adjustable base frame;

a person load and unload assembly mounted to a portion of the support structure wherein the assembly includes a person receiving portion adapted to

change configuration between a load and unload condition;

an actuator mechanism mounted on the base frame adapted to selectively control the assembly between a load and unload operating condition;

wherein in a load operating condition the assembly urges the person receiving portion thereof to adopt an angled position relative to the wheeled base to stably receive an person person for transfer; and

wherein when the actuator mechanism is selected for an unloading operating condition, the assembly alters the angle of the person receiving portion to allow transfer of the person person from the transfer device.

The applicant has found that the present invention Better Electric Person load and unload device improved the capability and efficiency to load and unload and transfer a person with disability compared to prior alternative devices.

The adjustable wheeled base frame can include a pair of spaced apart wheel spans pivotally interconnected by a first cross-arm, and wherein the space between end portions of the wheel spans distal to the first cross-strut is pivotally adjustable to receive a wheelchair or chair or the like therebetween.

The support structure can include two arm members interconnected to the wheeled base frame at pivot mounts on the frame, and wherein the arm members extend longitudinally and centrally of the wheeled base frame ending in another support for receiving the person load and unloading assembly thereon.

The support arm members can form a substantially y-shape.

The person load and unloading assembly can include a series of interconnecting pivoting arms ending in a body support structure for mounting the person receiving portion thereon.

There can be person load and unload transfer device wherein the person load and unloading assembly interconnecting pivoting arms are adjustable in length.

The interconnecting arms of the person support assembly can be acted upon by the actuating mechanism to allow change in configuration of the arms between a loading operating configuration and an unloading operating configuration.

The person receiving portion can include a chest support, wherein the chest support is angularly adjusted by the person load and unload assembly for load and unloading a person.

The seat attachment can be mounted by the chest support, which is adapted to support the persons weight to aid lifting and/or transfer of the person from a seated position to a load and transfer position on the device.

The seat attachment can be swivelably attached to the chest support so that the seat attachment means remains substantially in the same position independent of the angular position of the chest support.

There can be a seat arrangement allowing the seat to slide into the potential space under the persons legs and over the chair or the like while the material covering the seat does not slide over either the person's legs or the chair but rather rolls onto the surface of the persons legs and the supportive chair or the like.

There can be a fastening means attached to the person receiving portion of the assembly for fastening about the torso of an person person when in a load and transfer position.

There can be a person transfer load and unload device substantially as hereinbefore disclosed with reference to any one or more of the drawings.

There can be a method of loading and unloading a person for transfer, the method including:

providing an person load and unload transfer device including:

an adjustable wheeled base frame;

a support structure movably mounted on the adjustable base frame;

a person load and unload assembly mounted to a portion of the support structure wherein the assembly includes a person receiving portion adapted to change configuration between a load and unload condition;

an actuator mechanism mounted on the base frame adapted to selectively control the assembly between a load and unload operating condition; the method comprising:

a. adjusting the wheeled base frame to receive a chair or wheelchair or the like therebetween;

b. supporting the person on the receiving portion of the assembly

c. operating the actuating mechanism to urge the person receiving portion into an angular position for receiving the chest of the person in a load and transfer condition;

d. transferring the device to a desired location;

e. operating the actuating mechanism to alter the angular position of the person receiving portion to an unloading condition so that the chest of the person is moved towards a more upright position for unloading;

f. releasing the seat portion from the person receiving portion so that the person can be received on a wheelchair or bed or other support located between the wheeled frame.

g a seat mechanism that slides into the potential space under a persons legs

### BRIEF DESCRIPTION OF FIGURES

FIG. 1. This is an elevated and side on view which shows the base upon which is mounted the person support structure.

FIG. 2 This is a pure side elevation. This shows the person support structure mounted on the base by the pivot at 7.

FIG. 3 side elevation showing chest strut having moved up and to the right form its position in FIG. 2. under the influence of its linear actuator.

FIG. 4 Side elevation showing movement of the person support structure with movement of the primary linear actuator

FIG. 5 shows a person sitting on his seat or other furniture with the seat under his thighs

FIG. 6 Shows the person loaded on to the device and seated on the seat support and chest strapped with strap 61 to said chest support.

FIG. 7 A Shows a magnified cutout of FIG. 5.

FIG. 7 B shows a further magnified cutout focusing on crossbeam swivel mechanism of the seat and controlling joystick

FIG. 8 Seat mechanism in its simplest form—mainly front but slightly side elevation.

FIG. 9A Preferred embodiment of the seat A front on view of the seat as if looking from on to the seated patient) showing the seat above the persons thighs (circles)

FIG. 9B The same view with seat deployed

FIGS. 10 A, B, C Progressively magnified front view of the patient seat support, seat rollers and belt

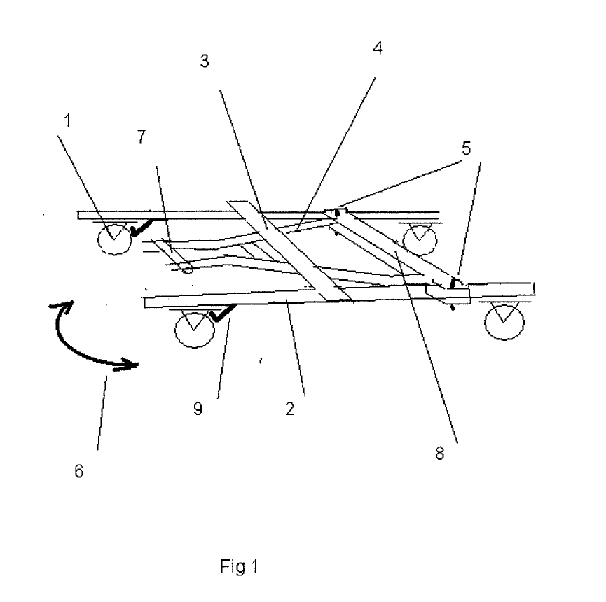

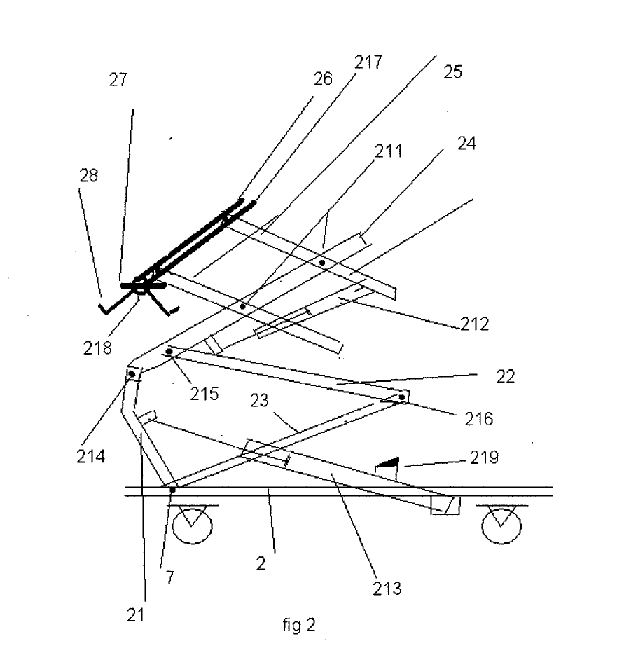

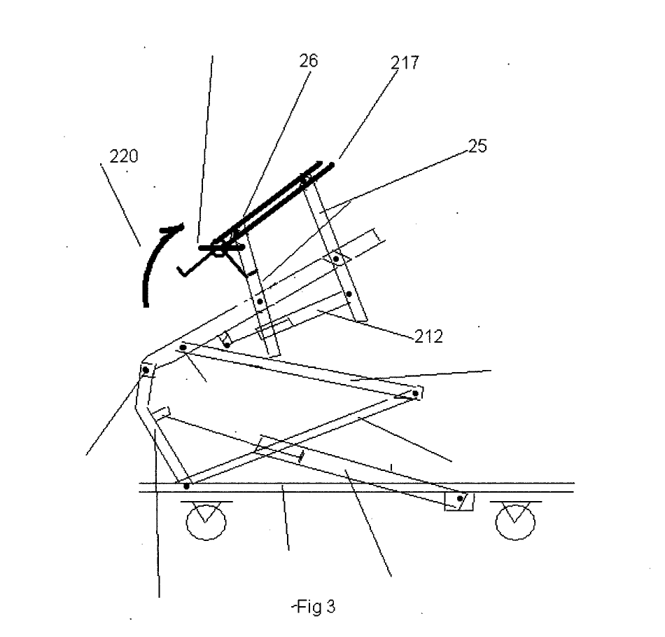

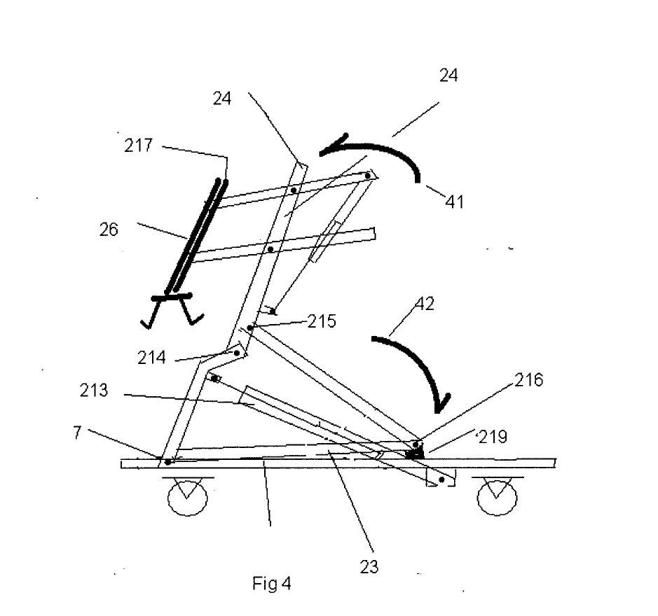

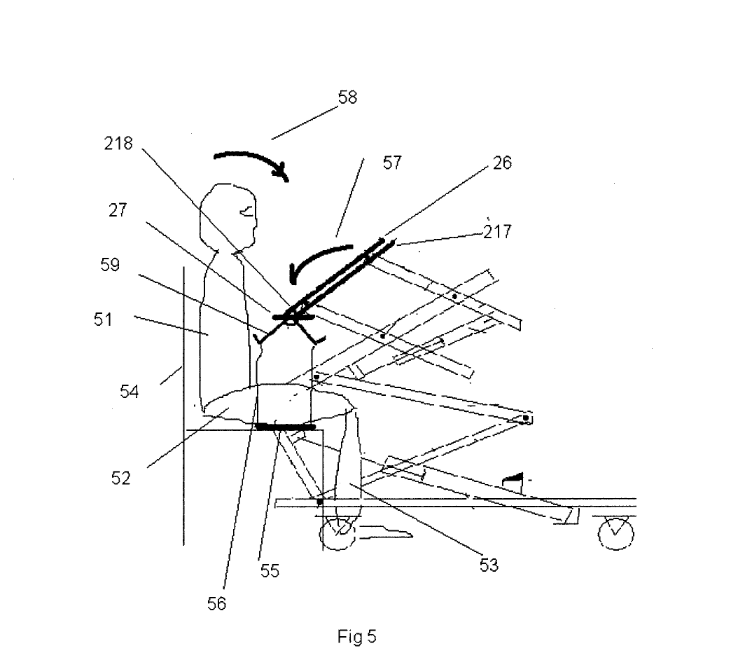

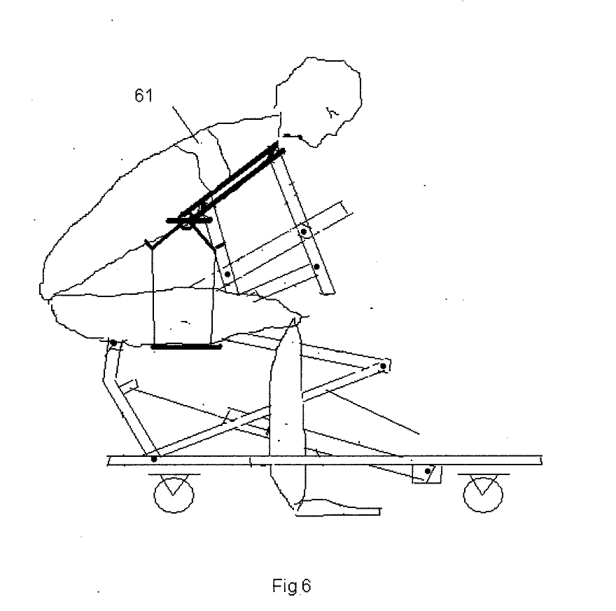

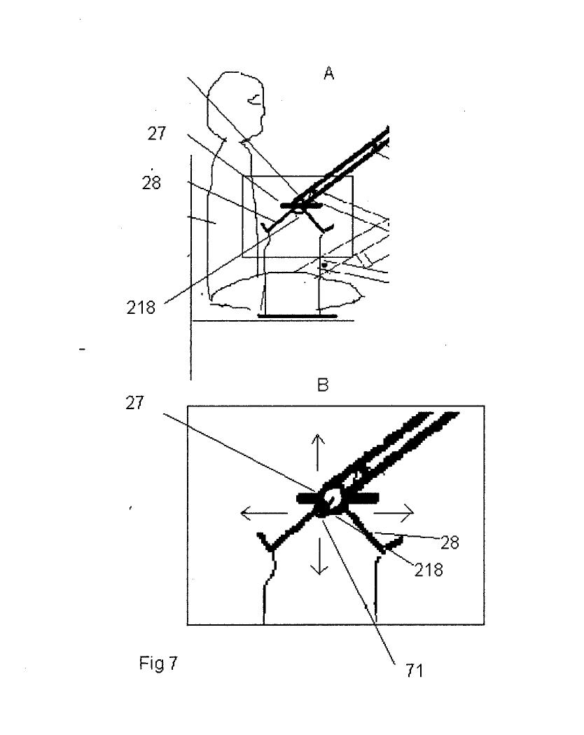

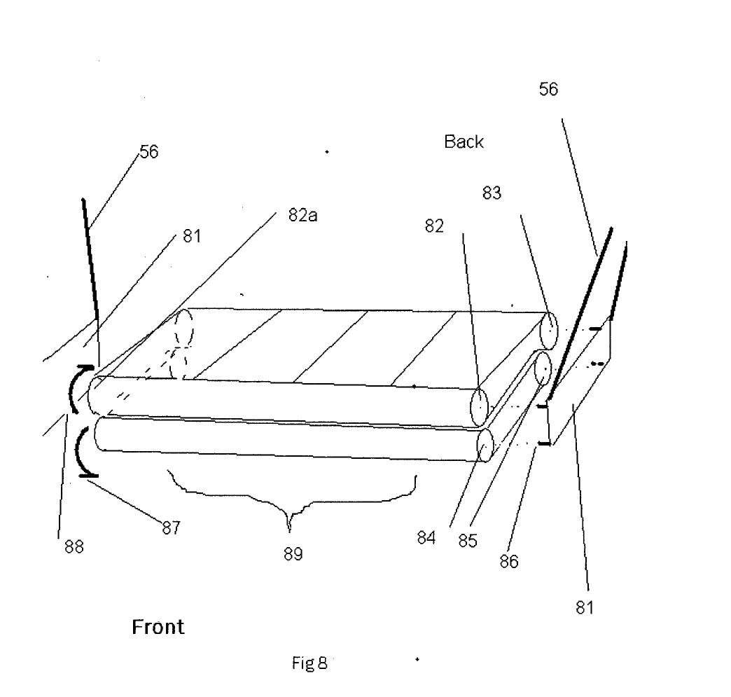

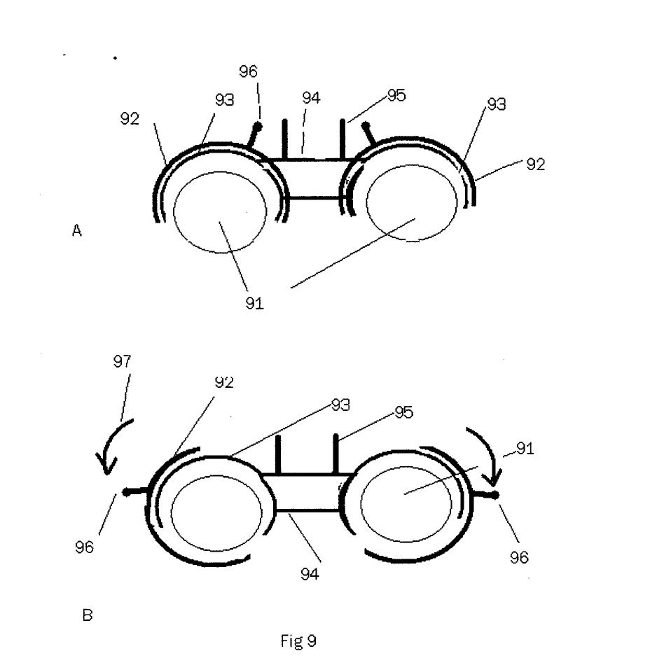

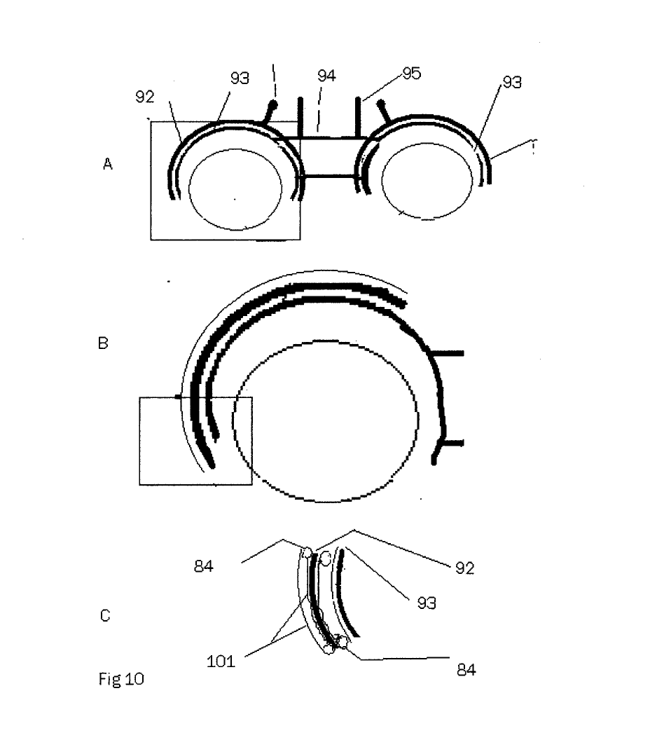

1. A person load and transfer device including:
an adjustable wheeled base frame having an open end for receiving a person therewithin;
a base including two arm members interconnected to a wheeled base frame wherein the arm members form a substantially y-shaped frame converging to form a y-support structure suspended centrally of the wheeled base frame within the open end so that a person can straddle the y-support structure;
a person support structure mounted to the y-support structure wherein the person support structure is adapted to change configuration between a load condition for receiving a person a transfer condition and an unload condition;
a first actuator mounted on the base frame and connected to the person support structure for selectively controlling the configuration of the person support structure for each of the loading, transferring and unloading operating conditions;
a person support means mounted to a portion of the person support structure for receiving a person for transport;
wherein in a load condition the person support structure is configured by the first actuator to position the person support means forward of the wheeled base frame to stably receive a person from a seated position; and
wherein in a transfer condition the configuration of the person support structure is altered by the first actuator so as to position the person support means towards a central portion of the wheeled base frame and to allow transfer of the person by the transfer device stably from one location to another; and
wherein in an unload condition the configuration of the movable support is further altered by the first actuator so as to position the invalid person support means forwardly of the wheeled base frame to allow unloading of the invalid person.

2. A person load and transfer device according to claim 1 wherein the person support structure includes:
a series of adjustable interconnecting pivoting struts ending in a body support structure for mounting the person support means thereon wherein the intersecting pivoting struts form a quadrilateral assembly at their points of intersection, which undergoes a change in configuration as it is urged by the first actuator between a forward loading position and a central position relative to the wheeled base frame;
a block structure mounted on a portion of the base for limiting movement of the quadrilateral assembly and causing its shape to change between a load and unload condition; and
wherein in a load or unload condition a portion of the quadrilateral assembly abuts the block structure whereby the person support means is maintained in a substantially upright position for loading or unloading of the person.

3. A person load and transfer device according to claim 1 further including a second actuator mounted between the quadrilateral assembly and the body support structure wherein the person support means is movable relative to the person support structure by the second actuator to assist support and positioning of the person during load, transfer and unload conditions.

4. A person load and transfer device according to claim 1 wherein the adjustable wheeled base frame includes a pair of spaced apart wheel spans connected by a first cross-strut and wherein the space between the end portions of the wheel spans, distal to the first cross-strut, is pivotally adjustable to receive a wheelchair or chair or the like therebetween.

5. A person load and transfer device according to claim 1 wherein the base includes the said two arm members interconnected to the wheeled base frame at pivot mounts on the frame, and wherein the arm members extend longitudinally and centrally of the wheeled base frame forming a y-support structure for receiving the person support structure thereon.

6. A person load and transfer device according to claim 2 wherein in an operating condition the interconnecting struts of the person support structure are acted upon by the first actuating mechanism to allow change in configuration of the struts between a loading operating configuration and an unloading operating configuration.

7. A person load and transfer device according to claim 1 wherein the person support means includes a chest support, wherein the chest support is angularly adjusted by the person load and unload structure for load and unloading a person.

8. A person load and transfer device according to claim 7 further including a seat assembly mounted by the chest support, the said assembly is adapted to support the person's weight to aid lifting and/or transfer of the person from a seated position to a load and transfer position on the device.

9. A person load and transfer device according to claim 8 wherein the seat assembly means is swivelably attached to the chest support so that the seat assembly means remains substantially in the same position independent of the angular position of the chest support.

10. A person load and transfer device according to claim 1 further including a fastening means attached to a person receiving portion of the person support structure for fastening about the torso of person when in a load and transfer position.

11. A person load and transfer device including:
an adjustable wheeled base frame having an open end for receiving a person therein;
the adjustable wheeled base frame includes a y-support structure;
a person support structure movably mounted to a portion of the y-support structure between a load and transfer condition;
a first actuator mechanism mounted on the base frame adapted to selectively control the configuration of the person support structure between a load and transfer condition;
wherein the person support structure includes:
a series of adjustable interconnecting pivoting struts ending in a body support structure for mounting the person support means thereon, wherein the interconnecting pivoting struts form a quadrilateral at their points of connection, which undergoes a change in configuration as it is urged by the first actuator between a forward loading position and a central transfer position relative to the wheeled base frame; and
a block structure mounted on a portion of the base for directing movement of the quadrilateral in a load and unload condition;
a person support means mounted to a portion of the movable person support structure for receiving a person for transport;
wherein in a load condition the movable person support structure is configured by the first actuator to position the person support means forward of the wheeled base frame to receive a person from a seated position, wherein a portion of the quadrilateral abuts the block structure to maintain the person support means in a substantially upright position for loading of the person; and
wherein in a transfer condition the configuration of the movable support is altered by the first actuator so as to position the person support means towards a central portion of the wheeled base frame and to allow transfer of the person by the transfer device stably from one location to another

12. (canceled)

13. (canceled)

14. (canceled)

15. (canceled)

16. A method of loading and unloading a person for transfer, the method including:
providing a person load and unload transfer device including:
an adjustable wheeled base frame;
a wheeled base frame with movable wheel spans;
a person support structure mounted to a portion of the base wherein the person support structure includes a person receiving portion adapted to change configuration between a load and unload condition;
the said person receiving portion includes a seat that includes rollers to assist in locating the seat under the person to be transferred;
a first actuator mounted on the person load and unload device adapted to selectively control the person support structure between a load and unload operation condition;
the method including:
adjusting the wheeled base frame to receive a chair or wheelchair or the like therebetween;
approximate placement of the person load and transfer device by wheeling close to the person's torso,
accurate placement of the device by movement of the person support structure on its wheeled base frame thereby locating the seat of the person receiving portion relative to the thighs of the person to be transferred so that the seat can be slidably rolled under the person, thereby supporting the person on the person receiving portion of the person support structure,
then supporting the chest of the person on a chest support, then securing the chest of the person to the chest support via retraining means,
then operating the actuating mechanism to first lift the person, then cause the person receiving portion to pivot relative to the person support structure so that the person is supported initially in an angular position relative to the support structure and then in an upright and central position as the person is being transferred;
transferring the device to a desired location;
operating the actuating mechanism to cause the person receiving portion to pivot back relative to the support structure so that the person sits back into their original angular position, then the person is lowered onto a suitable support at the desired location such as a bed or a toilet seat that is located between the wheeled frame;
releasing the seat support from the person receiving portion so that the person is detached from the transfer device.

17. A person load and transfer device according to claim 8 wherein a seat includes two pairs of rollers mounted by axles onto a pair of end plates, whereby the rollers are covered by a material belt so that as the seat is pushed between the person's legs and furniture, the material belts roll over the surface of both the person's legs, and furniture in a substantially reduced friction manner to assist placement of the person on the seat.

18. A person load and transfer device including:
an adjustable wheeled base frame having an open end for receiving a person therewithin;
a y-support structure mounted on the adjustable wheeled base frame, the y-support structure including two arm members interconnected to the adjustable wheeled base frame substantially at opposite pivot mounts on the wheeled base frame, the said y-support structure is positioned centrally of the wheeled base frame within the open end so that a person's feet can straddle the y-support structure;
a person support structure swivelably mounted to the y-support structure wherein the person support structure is adapted to change configuration between a load condition for receiving a person, a transfer condition and an unload condition;
a first actuator mounted on the person load and transfer device, connected to the person support structure for selectively controlling the configuration of the person support structure for each of the loading, transferring and unloading operating conditions; and
a person support means mounted to a portion of the person support structure for receiving a person for transport;
wherein the person support structure alters configuration between a load, transfer and unload condition so as to distribute the weight of the person received by the person support means centrally of the wheeled base frame and about the person support structure to stabilize the wheeled base frame during load, transfer and unload operations.

19. A person load and transfer device according to claim 18 wherein the person support structure includes a series of adjustable interconnecting pivoting struts ending in a body support structure for mounting the person support means thereon, wherein the intersecting pivoting struts form a quadrilateral assembly at their points of intersection, which undergoes a change in configuration as it is urged by the first actuator between a forward loading position and a central position relative to the wheeled base frame.

20. A person load and unload transfer device according to claim 19 further including a block structure mounted on a portion of the base for limiting movement of the quadrilateral assembly in a load and unload condition, wherein in a load or unload condition a portion of the quadrilateral abuts the block structure whereby the person support means is maintained in a substantially upright position for loading or unloading of the person.

21. A person load and transfer device according to claim 1 wherein the person receiving portion includes a first pair of half-pipe supports that overlay the person's thighs, and each half-pipe in the pair has an associated second half-pipe concentrically located, so that when the first pair of half pipes overlay the person's thighs, each second concentric half pipe is adapted to either slide or roll around the periphery of its associated first half-pipe so that it is positioned under the lower portion of each of the person's thighs, thereby substantially surrounding and restraining the person's leg.
